(19) United States
(12) Patent Application Publication
(10) Pub. No.: US 2009/0048903 A1
(43) Pub. Date: Feb. 19, 2009

(54) Method and system for universal life path decision support

(75) Inventor: Barry S. Lieberman, Mountain View, CA (US)

Correspondence Address: Patent Crafters, 3815 Crownpoint Ct., Suite 200, Carlsbad, CA, 92010, US

(73) Assignee: Universal Passage, Inc.

(21) Appl. No.: 12/157,458

(22) Filed: Jun. 11, 2008

Related U.S. Application Data
(60) Provisional application No. 60/964,462, filed on Aug. 13, 2007.

(51) Int. Cl. G06Q 30/00

(52) U.S. Cl. 705/10

(57) ABSTRACT

A method for life path decision support. Methods or computer programs are used for collecting a person's true or prophetic biographical and goal-related data. Such data is used in the creation of a mathematical representation of a profile. Similar profiles are created by various goods or service providers. Methods or computer programs are used for creating mathematical, multi-axis objects that match a person's articulated or implied life path needs or goals to one or more goods or service providers. Polynomial matchmaking as well as heuristic matchmaking is employed. Matches are filtered, ranked and presented, typically using a computer screen. Support groups or industry-specific groups or other groups may be formed automatically based on the profiles or matches. Neither the patentee nor the USPTO intends for details set forth in this abstract to constitute limitations to claims not explicitly reciting those details.

### CLAIM OF PRIORITY

This application claims the benefit of U.S. Provisional Patent Application 60/964,462 entitled “METHOD AND APPARATUS FOR PROVIDING AN ONLINE UNIVERSAL LIFE PASSAGE PROGRAM” by Barry Lieberman, filed Aug. 13, 2007 (Attorney Docket No. LIEB-P0001), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document, or the patent disclosure, as it appears in the Patent and Trademark Office patent file or records, but otherwise reserves all copyright rights.

### FIELD OF THE INVENTION

The current invention relates generally to decision support systems, and more particularly to decision support systems for life passage decision support.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Throughout the evolution of mankind, mankind has forever been faced with the inevitable truth that the characteristics of life change over time. In modern times, the needs associated with the characteristics of how life changes over time have been at least partially addressed by a wide range of services available to an individual or his/her family and others for whom they may be responsible or act as caregivers. Such services include associated or disassociated programs, products or services for financial planning, insurance, medical needs, legal services, burial services, etc.

Unfortunately, while a broad range of services are available to an individual, various sociological barriers limit the reach that the aforementioned service providers have to their prospects, and vice versa. In fact, many aspects of a coordinated life plan are counterintuitive. Consider for example that the ‘best’ time to buy life insurance is when one is quite young—at which time there are generally few assets and few dependents to protect. On the other side of the scale, consider that a very old person who may be in failing health and in diminished soundness of mind is not in an optimal situation to work through the legalese of a will and testament, and durable power of attorney, and so on.

Additionally, knowledge barriers are before individuals. That is, even if one senses the need for, say, prudent financial planning, there exists such a myriad of options available to the individual, and also such a large corpus of knowledge needed in order to make an informed decision that, too often, life path decisions tend to go unaddressed. Add still to that the sociological fact that people are often reluctant to share their situations with others, resulting in the consequence that people often do not even know what questions to ask, or to whom to ask the questions once known. Moreover, unlike other challenges present in modern life (e.g. bankruptcy, drug and alcohol counseling, cancer survivorship, self-awareness, etc.), there are generally no support structures that holistically integrate making life path decisions that people face, or will face.

To a limited extent, social networking via the Internet is positioned to ameliorate some of the aforementioned barriers, in particular geographic barriers and privacy issue barriers. However the state of social networking today still does not foster awareness and understanding of life path decisions, nor does it broadly provide mentored support structures for individuals to link up with other individuals who may share some of the same life decision situations. In any case, current social networking sites do not provide any significantly structured experience where wisdom can emerge from amongst a sometimes overwhelming sea of knowledge that is shared only to varying degrees, nor does it provide easily accessible paths to obtain services needed once certain life path decisions have been made.

These and other deficiencies, in turn, lead to the need for the present invention.

### SUMMARY OF THE INVENTION

A method for life path decision-making support. Methods or computer programs are used for collecting a person's true or prophetic biographical and goal-related data. Such data is used in the creation of a mathematical representation of a profile. Similar profiles are created by various goods or service providers. Methods or computer programs are used for creating mathematical, multi-axis objects that match a person's articulated or implied life path needs or goals to one or more goods or service providers. Polynomial matchmaking as well as heuristic matchmaking is employed. Matches are filtered and ranked, then presented, typically by using a computer screen. Support groups or industry-specific groups or other groups may be formed automatically based on the profiles or matches.

### BRIEF DESCRIPTION OF THE DRAWINGS

FIG. 1 is a depiction of a method for providing universal life path decision support, according to one embodiment.

FIG. 2A is a depiction of a method for collecting general member data, according to one embodiment.

FIG. 2B is a depiction of a form for collecting member biographical and statistical data using a screen device, according to one embodiment.

FIG. 2C is a depiction of a form for representing collected member data using slider screen devices, according to one embodiment.

FIG. 2D is a depiction of a form for representing collected member data using slider screen devices, according to one embodiment.

FIG. 2E is a depiction of a login page using screen devices, according to one embodiment.

FIG. 3 is a depiction of a method for collecting provider data, according to one embodiment.

FIG. 4 is a depiction of a method for creating a provider match object, according to one embodiment.

FIG. 5 is a depiction of a group of template objects, according to one embodiment.

FIG. 6 is a depiction of a method for matching a member's match object to other member's match objects, according to one embodiment.

FIG. 7 is a depiction of a method for matching a member's match object to a provider's match objects, according to one embodiment.

FIG. 8 is a depiction of a method for preparing a multi-valued dataset for presentation, according to one embodiment.

FIG. 9 is a depiction of a method for presenting a multi-valued dataset, according to one embodiment.

FIG. 10 is an illustration of an environment in which the method for providing universal life path decision support can be practiced, according to one embodiment.

FIG. 11 is an illustration of an apparatus upon which a computer program product embodied on a tangible computer-readable medium for providing universal life path decision support could be practiced, according to one embodiment.

For purposes of clarity and brevity, like elements and components will bear the same designations and numbering throughout the Figures.

### DETAILED DESCRIPTION

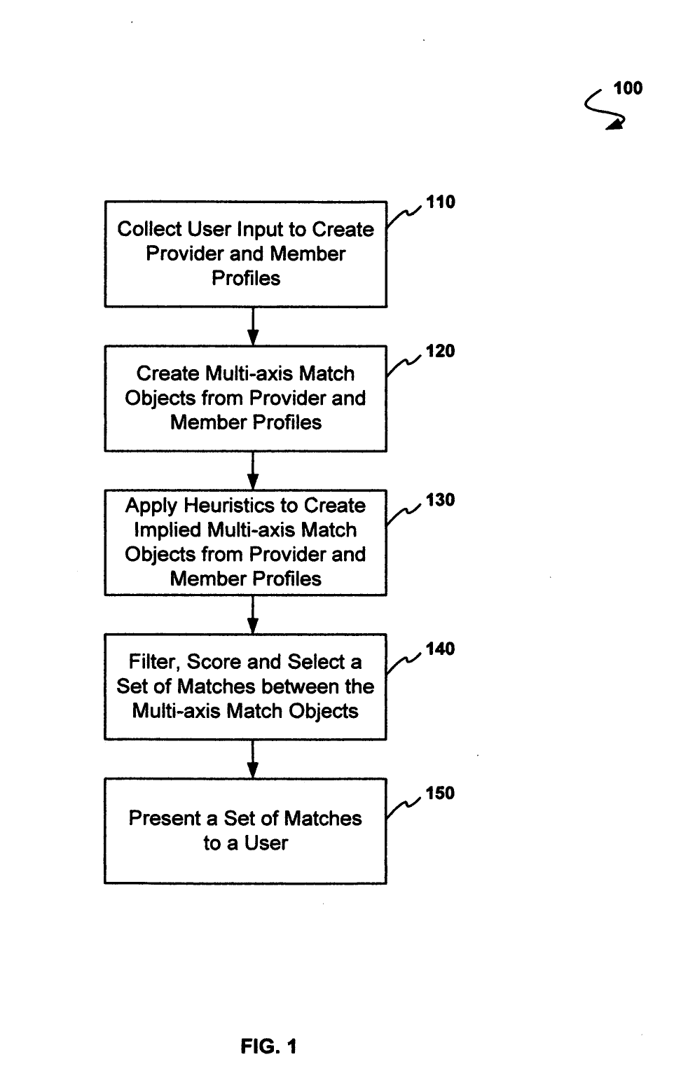

FIG. 1 depicts a system for universal life path decision support 100 wherein persons with life path decision support needs are matched to others with similar life path decision support needs and wherein persons with life path decision support needs are matched with providers who can address those needs. In a gross generalization, this is a process of matching a buyer to a seller. However, in the traditional marketplaces the commodity to be exchanged for valuable consideration is most typically a well understood quantity (e.g. a 1967 Mustang convertible, or 100 shares of GOOG). Moreover in the case of life decision support, even though ultimately some specific commodity might be uniquely identifiable, the process and timing of selection of such a commodity is vexing. Strictly as examples and not to be limiting, aspects and components of the process and timing of selection of such commodities might include the timing of the purchase of situationally appropriate insurance products; managing and protecting one's personal identification dataset; defining successful marriage and family protocols, especially in stressful situations; using one's genealogical history as the basis of forming an intergenerational communication of personal goals and ethical values from within which critical life decisions can be more productively structured; planning for the care and well-being of pets; purchasing or investing in real property; making successful choices in selecting local electrical, plumbing, construction and other contractors to remodel or upsize/downsize homes; handling estate property valuations and dispositions; detecting perpetrators of fraudulent offerings of products and services; career planning and entrepreneurial ventures; bookkeeping, compliance accounting and forward-looking tax planning; financial and estate planning; general legal planning and specific services such as formation of Trusts, estate conveyance, Advance Health Care Directives, Will and testamentary services; caring for personal needs throughout the normal life cycle including medical services, in-home care giving, assisted living, geriatric case management, hospice and palliative care; managing the emotional and financial ravages of degenerative diseases; planning for end-of-life memorials and funerals, etc.

Indeed, traditional (or ad hoc) avenues to life path decisions are rife with pitfalls (e.g. no time to address decisions, overwhelming situations and paralyzing worry, rapidly changing life situations, reluctance to ask questions, inability to find support, lack of awareness or education, etc), and often, life path decisions are delayed until it is too late, or they are sometimes left entirely to chance. The system disclosed herein traverses the identification of needs, often followed by the identification of support systems, often followed by the identification of service providers, and finally the identification of one or more specific service areas of practice.

The dynamic orchestration of these endless and currently disparate or minimally and loosely associated life cycle activities is addressed in the embodiments of the invention presented herein. The methods can be practiced by a host (e.g. a website operator) or may be practiced by proxy under one or more licenses that may include privately branded niche licenses or purposes may cover the virtual world or ‘the real world’, or both. Real world environments may include everyday situations such as at work; through affiliation with social, civic, ethnic and religious organizations; high-net-worth or other market segment populations; and at in-real-world neighborhood meetings, exhibitions and conferences. Such licenses may be used to support aspects of providing materials for a life path and financial literacy seminar series; etc.

By way of an oversimplified description using the buyer-seller paradigm, the system for universal life path decision support 100 must collect information from the buyer (member) and seller (provider), morph that information into a form that a computer can understand, apply some rules to make assumptions or inferences about the needs of the buyer (member), and then present to the buyer (member) one or more sellers (providers) capable of providing the needed commodity, or otherwise servicing the needs of the buyer (member).

While this paradigm is easy to understand, it is the enablement of one or more embodiments of the present invention that comprise the disclosure herein. As a practical matter there may be different levels of access to or availability of features, benefits or functionality found amongst the disclosure herein as well. It should be strongly noted therefore that the following information is set forth for illustrative purposes and should not be construed as limiting in any manner. Any of the following features may be optionally incorporated with or without the exclusion of other features described. In particular, various systems and methods and operations are presented here to the extent that one skilled in the art may readily make and use the invention herein. To wit:

FIG. 1 depicts a method for universal life path decision support 100 comprising a group of operations which work in conjunction with each other. As shown there is a progression from one operation to another, however in various embodiments, any one operation can execute in any order, such order being executed independently of the execution of any other operation. The method for universal life path decision support 100 includes an operation for collecting user input to create provider and member profiles 110; an operation for creating multi-axis match objects from provider and member profiles 120; an operation for applying heuristics to create implied multi-axis match objects from provider and member profiles 130; an operation for filtering, scoring and selecting a set of matches between the multi-axis match objects 140; and an operation for presenting a set of matches to a user 150. Now, we cover these operations in somewhat more detail in the following paragraphs.

Shown in FIG. 1 is an operation for collecting user input to create provider profiles and member profiles 110. In any market of any sort where there are goods or services to be exchanged, there must be both buyers and sellers. In the context of the present invention, buyers are termed “members” and sellers are termed “providers”, and references herein to “users”, or “user's” or a “user” or “a user's” may refer to a person or persons associated as a member or a person or persons associated as a provider, or both.

For the purpose of using one or more computing platforms to match members and providers, a technique is provided for creating a profile for each member and for each provider. On the basis of the contents of the profiles, members and providers can be matched. Also, various techniques are provided infra for creating the profiles, and also are provided techniques for creating and using specialized data structures for various forms of matching.

Shown in FIG. 1 is an operation for creating multi-axis match objects from provider and member profiles 120. The term “multi-axis match” in the context of the present invention refers to the fact that a match between one match object and any other match object (whether a member's match object or a provider's match object) may be matched for closeness on the basis of n-space distance, dissimilarity measure, or one or more ultrametrics. It must be recognized that the closeness of a match with regard to a particular axis (variable) may be a simple matter of arithmetic (e.g. how close is the integer 7 to the integer 10?) or it may be more subjective (e.g. how close is a career planner to a life coach?, or how close is a will to a testament?), or a match on a particular variable may be made on the basis of a non-linear function (e.g. if one resides in New York, a hospice facility located in Kentucky is not appreciably closer than a hospice facility located in Alaska). In fact, a number of techniques for computing similarities and dissimilarities and for identification of clusters (e.g. single-link, complete link, partitioning around medoids, etc) may be employed for the matchmaking operations described herein.

Shown in FIG. 1, is an operation for applying heuristics to create implied multi-axis match objects from provider and member profiles 130. One can readily recognize that capturing a member's profile by the technique of questions and answers has practical challenges. The subjectivity of those variables can be objectified when the member enters their personal data into their Life Path Profile Organizer (also referred to herein as a Life Path Profile or member profile)

In the context of the present invention are various aids including the application of heuristics to automatically create and automatically populate implied multi-axis match objects from provider and member profiles. For example, a member who completed a portion of his/her own profile indicating his/her age as 22 years old would likely have an extremely high interest in matching to career development services. As such, the operation applies heuristics to create implied multi-axis match objects from provider and member profiles 130 relating to career building to the member (see operation 206, below). On the contrary, for example, a member who completed a portion of his/her own profile indicating his/her age as 22 years old would likely have an extremely low interest in matching to, for example, a geriatric care facility, and thus it might happen that no provider matches are offered to that member for that practice area.

Also shown in FIG. 1 is an operation for filtering, scoring and selecting a set of matches between the multi-axis match objects 140. In most competitive markets, there are many sellers (providers) who compete for the opportunity to fulfill the needs of a prospect (member). However, for practical reasons, very few providers can be contacted or personally evaluated by the member; thus, there is a need for the system 100 to be able to filter out impossible or known undesirable providers, and further a need to score or rank the remaining providers such that the highest-scoring or most likely matches are presented to the member in some order. Conversely, from the provider's side, the task of finding qualified leads (members) is also a filtering and scoring process. Various embodiments of the present invention describe mining a member database using one or more techniques for filtering and scoring a set of matches between the multi-axis match objects 140.

Also shown in FIG. 1 is an operation for presenting a set of matches to a user 150. In the context of the present invention, such a presentation to the user may be in the traditional form of an ordered list, or the presentation may employ more sophisticated techniques such as maps, funnels, 2-D, 3-D, or n-space charts, bar charts, pie charts, etc or even multi-page, navigable, and/or hierarchical presentations.

Now, with a fundamental understanding of the techniques employed in various embodiments of the invention for providing universal life path decision support, we can now turn to further details in how to make and use the invention and more illustrative information will be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

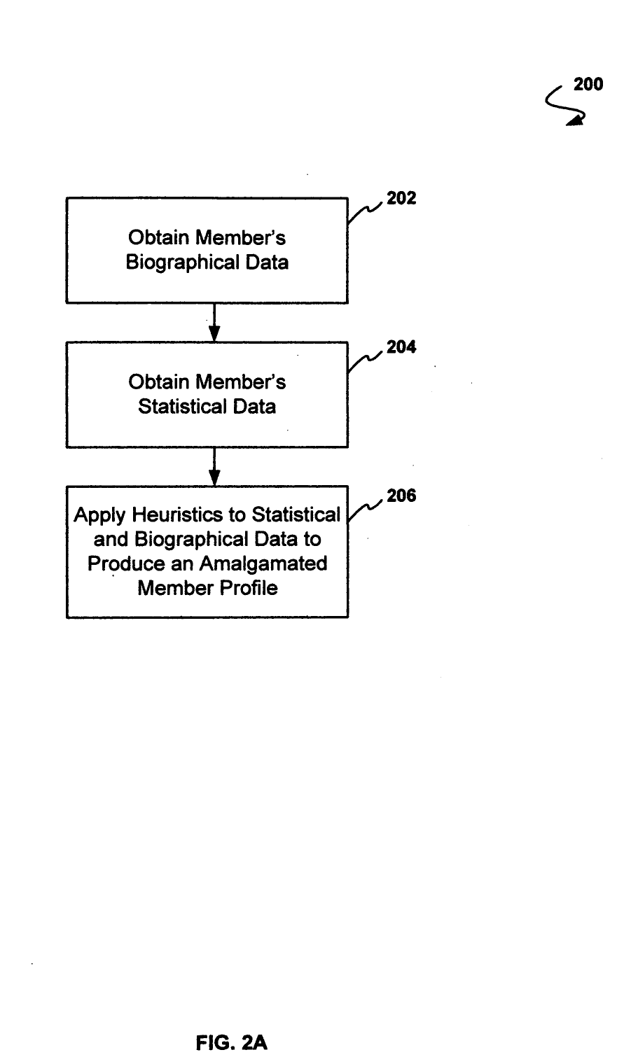

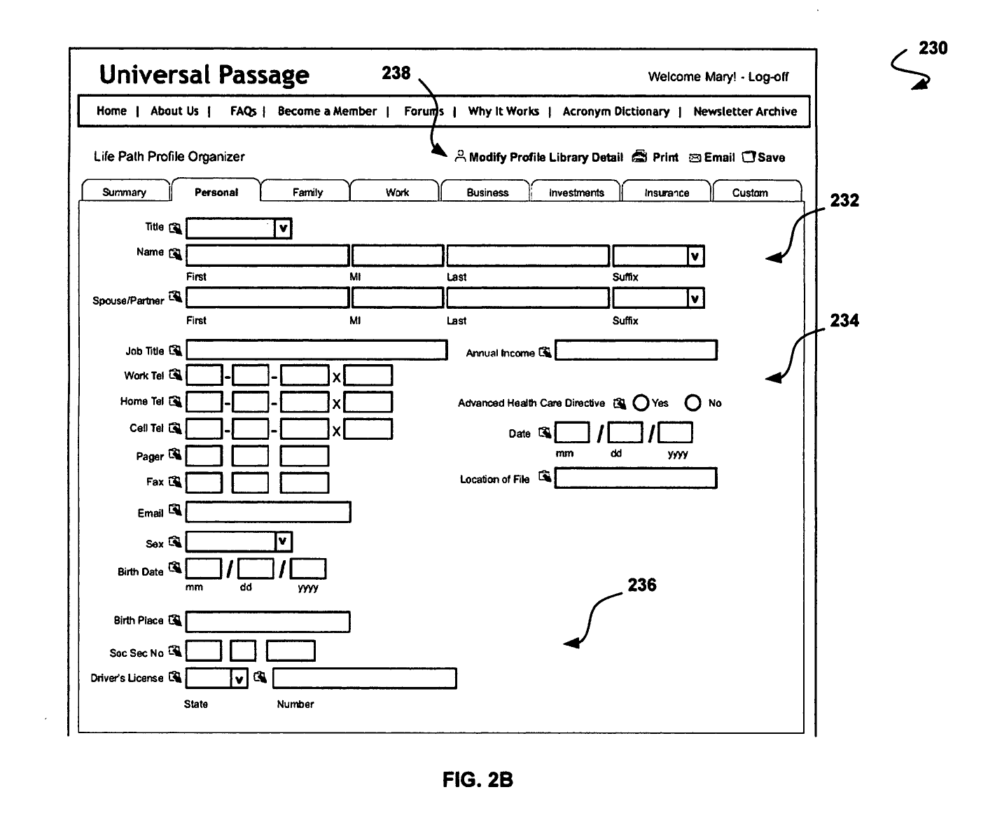

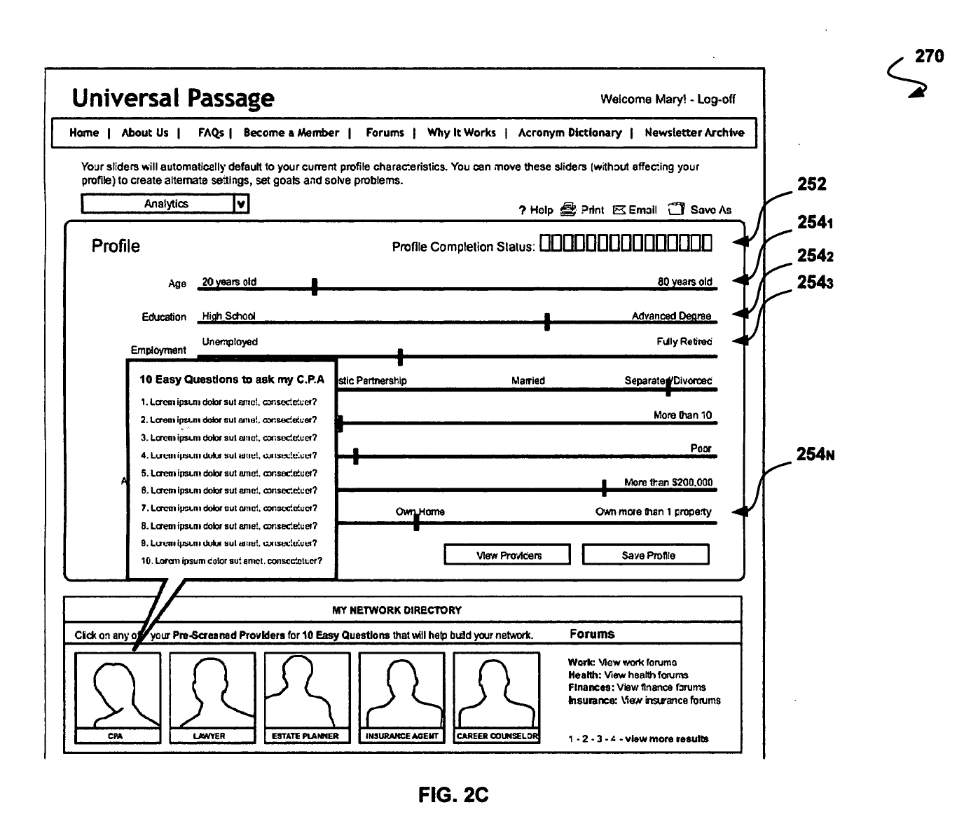

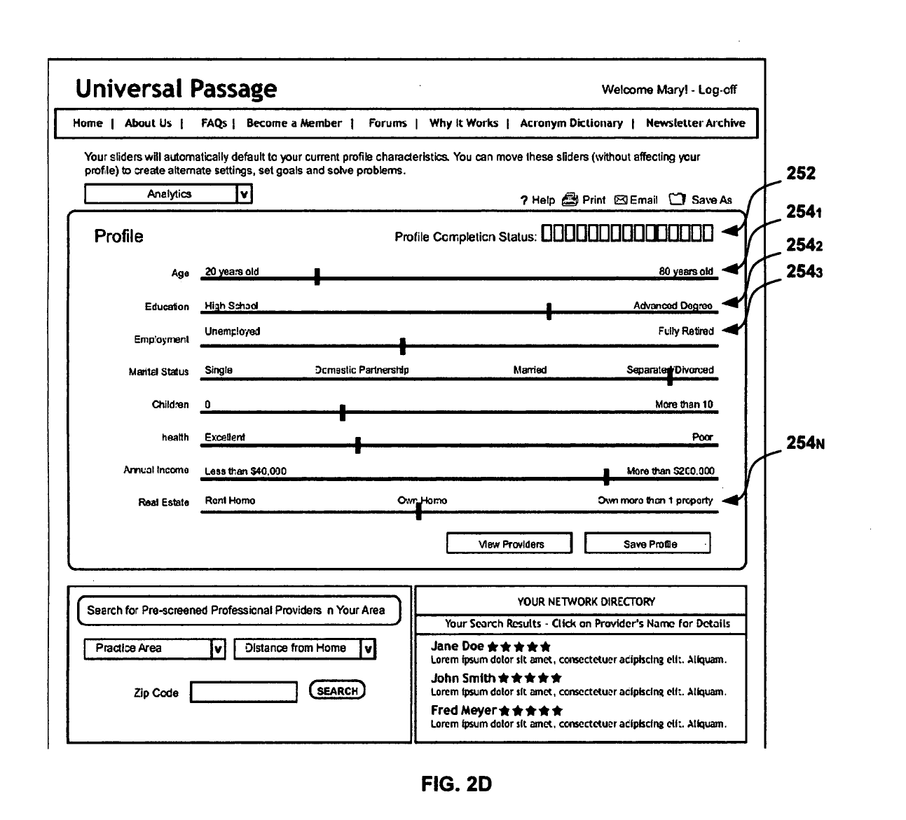

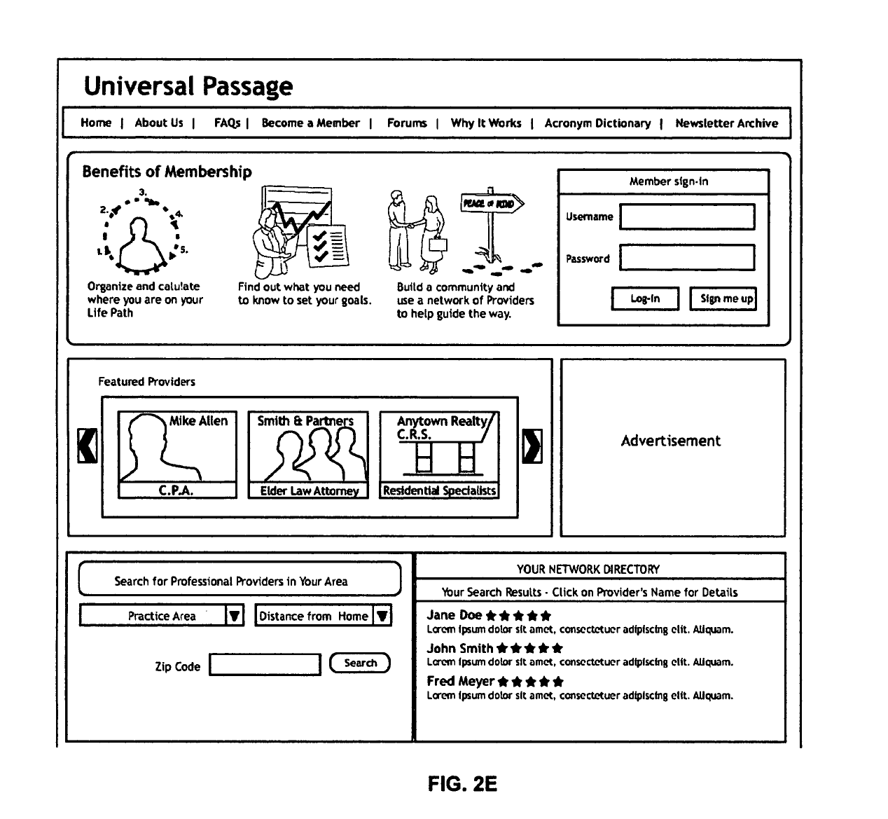

FIG. 2A shows a system 200 for collecting member input to create member profiles, in accordance with another embodiment. The member's biographical data may be obtained through any of the screen devices or other techniques discussed herein (see operation 202). Further, various statistical data may be correlated to the member. Such statistical data need not become part of the profile, in fact in a preferred embodiment, the statistical data is obtained and associated with the member profile only upon demand (for example upon a demand by the operation 206 for applying heuristics), thus as statistics change, the correlation to the user may change (operation 204). As an option, the present system 200 may be implemented in the context of the architecture and functionality of FIG. 1. Of course, however, the system 200 or any operation therein may be carried out in any desired environment. The aforementioned definitions may apply during the present description.

In particular, the manner by which a member's biographical and statistical data (also termed, “Life Path Profile”) is obtained can be found in FIG. 2B Such biographical data may include personal identification information such as name 232, telephone number 234, social security number 236, etc. And it may include additional information regarding the user's family situation, work situation, investments, insurance coverage types and limits, or even subjective information such as condition of health, favorite color, or favorite type of music. In addition to the fields shown in FIG. 2A (e.g. Title, Name, Spouse, etc), there may be additional fields, and in fact the list of fields and the content of those fields can be modified and extended by virtue of the editability (and extensibility) by either or both the member and/or the maintainer of said fields and field content data.

Further, the system 200 may include an operation for obtaining a member's statistical data (see operation 204). Such information need not be stored in the profile; in fact in preferred embodiments, the statistical information (e.g. percentile of Americans with the same level of education, deviation from mean as to number of children, percentile of Americans with the same stated income, etc) is calculated or retrieved each time the corresponding statistical information is needed. Such statistical information can be used in processes for matching a member to other members, or to providers. Still on the topic of collecting statistical information, some embodiments perform statistical analysis from within the groups of members and providers of the system 100. In fact, the results from the collection of statistical information from a group of provider profiles is used in the filtering and scoring operations.

In fact, various views of the data within a member profile may be created within the context of system 100. The views, termed subordinate profiles, may include any arbitrary view (e.g. subset of fields) of the member profile. In fact, various input devices including web page screen devices (see discussion of analytics, below) may provide access to these views. Subordinate profiles may include fields that compare member data to industry standards and optionally to other statistically significant population samples.

A member's Life Path Profile may also be populated through the linkage to third party products, although this is not required. Through this facility, data can be automatically populated to the member profile, and by logical extension to any views (subordinate profiles) of the member profile.

In some embodiments, and in the context of the system 200, the system 200 may present one or more explanations of one or more portions of a Life Path Profile, be it an industry-specific or member-created subordinate profiles. More generally, some embodiments of the system 200 may otherwise provide the member with any explanations, tips, help or behavioral motivation needed for completion of the steps 202 and 204.

In some embodiments, as shown in FIG. 2B, a summary screen may be presented to the user with a subset of the biographical information. In a preferred embodiment, the operation for obtaining a member's biographical data 202 may employ a screen device having a plurality of sliders 254₁-254_{N} for representing characteristics on a scale (see FIG. 2C). The sliders 254₁-254_{N} for representing characteristics on a scale may take on values according to a function relative to the dataset entered (see system 230), or as may have been entered using a screen device similar to the screed device depicted in FIG. 2B. Optionally the default setting of the sliders in the Life Path Profile Organizer may be manually moved to create and “saved as” to alternate “what if” scenarios. A particular “what if” scenario may then be saved using a name used for later retrieval (e.g. “barryat45yrsold”). Any particular configuration of sliders (i.e. a “what-if” scenario) can be used in order to produce a corresponding set of providers and relationship pre-qualifying questions as are discussed in detail infra (see operations 602 and 604).

In still other embodiments, the operation to obtain a member's biographical information may include a screen device having a progress bar 252. Via the graphical screen device, the progress bar reports the relative stage of data field completion based on statistical data including deviance within a range set by industry norms for certain characteristics. For example the stage of completion for a 22-year-old single male college graduate with $20K in loans outstanding earning $65K per year, etc might include selection of a CPA, but not selection of a final resting place. In this example, the progress bar might indicate a high degree of completion, indicating a narrow variance from industry and statistical norms. Conversely, a 65-year-old person who has not yet selected a hospice, nor a final resting place might show as a low degree of completion, indicating a wide variance from industry and statistical norms. Any “what-if” scenario may be saved for inclusion in the amalgamated member profile, and may be made available for later retrieval.

In the exemplary screen device 270, a portion of the screen may be dedicated to the display of matching providers. Display of the providers, is updated as the sliders are adjusted to reflect the member's “what-if” scenario. In fact it is envisioned that a member will use the sliders to input data corresponding to a family member's or loved-one's characteristics. In this manner a member can quickly identify providers that match to a particular “what-if” scenario—even a “what-if” scenario for another person.

In some embodiments, whenever the profile as depicted in a screen device 270 is showing a default profile (i.e. the member's profile), the display of providers includes only those providers that have not yet been selected by the member. For instance, if the member had selected a certain provider (e.g. “H and R Brick”) from the presentation of a group of providers (e.g. “Tax Preparers”), the system 100 would record such a selection, and neither “H and R Brick” nor any other providers of type “Tax Preparers” would appear on screen device 270.

In some preferred embodiments, the member's profile may be encrypted stored in secondary storage, or may be stored (encrypted or not) at some user-specified location, optionally including on a USB flash drive or into/onto a user-specified handheld device such as a mobile phone or smart phone or personal digital assistant. It must be emphasized that although in preferred embodiments the system 200 may run through all steps encapsulated in operations 202 and 204 prior to producing an amalgamated member profile it is possible (but strictly optional) to proceed with the operation of the system 100 even without completion of the operation 206. In similar fashion, a profile may be updated periodically as the member's situation changes (i.e. got a better job) or becomes clear or definable (e.g. advance health care directive codified).

Given a particular “what-if” scenario as defined by the member, guiding information, possibly including an alternate selection of pre-screened providers, are presented to the member. Moreover, as further guidance to the member, and as shown in FIG. 2C, a screen device may be used to display “10 Easy Questions”. The “10 Easy Questions” are industry-specific and changeable in number and actual quantity count over time. The “10 Easy Questions” serve as pre-qualifiers of a provider/member relationship and may serve to establish goals, needs and requirements of each party in the relationship.

In some cases, a provider may require information from the member. In such cases, one or more fields may need to be defined, populated by the member, and communicated to the provider. One provider-independent technique is shown in the lower left corner of FIG. 2D. Another technique might be to augment the member profile with provider-required fields, which might be specific to a provider-type or even specific to a particular provider. The provider-required fields are defined by an extensible provider-defined subordinate profile, and subsequent to member selection of a screen device to add profile detail 238, access to a library of provider-specified fields are presented for user population. Of course many techniques may be used to reduce the number of fields presented, such as presenting only the fields from the library that correspond to the user's selected providers.

One result of the practice of method 200 is an amalgamated member profile containing user-provided data, some of which may be sensitive, personal or otherwise not intended for unrestricted access by any other entity, person or computer program. Accordingly the amalgamated member profile may be singly or double password protected and optionally encrypted. In various embodiments employing double password protection a user may permit access (e.g. READ-ONLY, READ-WRITE, READ-PARTIAL, WRITE-PARTIAL etc) to entities, persons or computer programs whom the user specifically authorizes. For example, a user may specifically authorize access by people that the member has selected to act as their Financial and Healthcare Powers of Attorney. In some embodiments, one or more of a member's subordinate profiles are single password protected and optionally encrypted. Passwords may be member configurable and changeable. In some embodiments, user passwords are stored in encrypted forms.

Of course embodiments may present options to a user to communicate or allow managed access to all or part of a member's profile. Such access may be granted to specific providers or other users or advertisers, etc. with whom the user chooses to interact. In some cases access to such a communicated dataset may be possible only as long as the recipient has the applicable password. In various embodiments, selected types of communication of any changes to the underlying data (e.g. a member's profile) since their last communication may be depicted using a technique for highlighting such changed data. A copy of each authorization is retained and can be accessed on demand. As previously indicated, any field within the master Life Path Organizer database into which an entry is made, changed, or is added or removed by the member will automatically trigger modification of subordinate profiles in which the identical field is included. Of course a member may choose to back-up changes to any number of storage medium (USB key, hard drive, CD, etc.)

As mentioned above, in some cases, a member is presented with help, tips, or even audio/visual aids. The intent of such presentation is to aid the member in surmounting any barriers that might be in the way of completing any portion of their Life Path Profile. FIG. 2E depicts how a series of screen devices might be combined to provide a home page including graphical help, tips, suggestions, FAQs, access to newsletters, or even audio/visual aids.

The disclosure to this point has discussed techniques and operations for handling member profiles and the resulting data objects. In similar fashion will now be discussed operations performed that pertain to providers.

It must be recognized that to enhance usefulness from the first moment of operation, the system for universal life path decision support 100 might have a pre-populated set of providers. In various embodiments, the system 100 will employ techniques to either fully automatically, or in a computer-aided manner, pre-populate the system 100 with providers. To do so, it is convenient to define a method for presenting a provider profile to a user in the form of a ranking object 300.

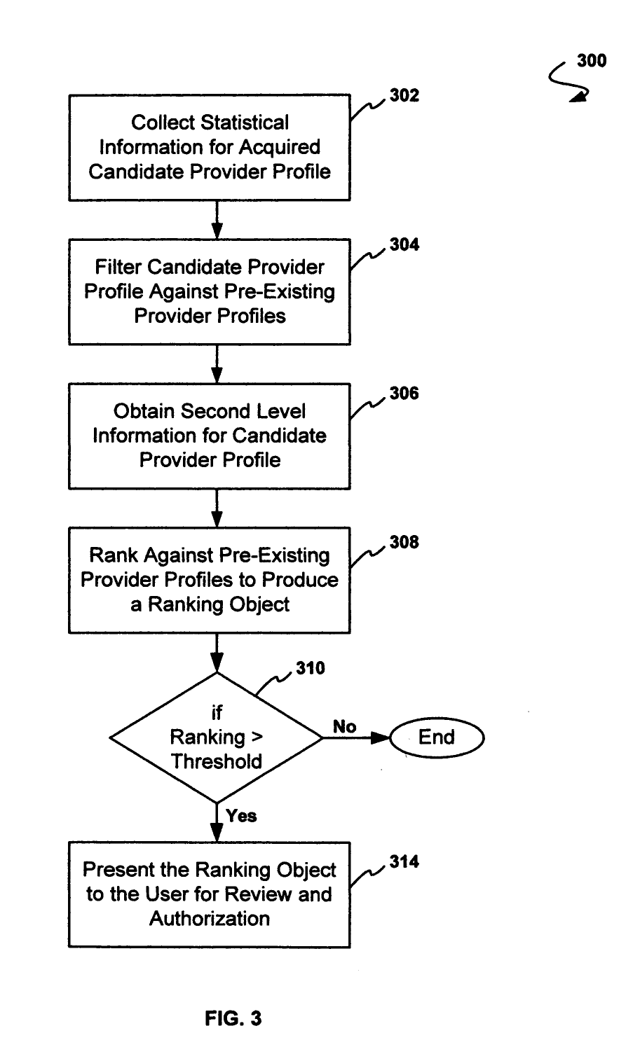

FIG. 3 shows a system for collecting provider input to create provider profiles 300, in accordance with another embodiment. As an option, the present system 300 may be implemented in the context of the architecture and functionality of FIG. 1 and FIG. 2. Of course, however, the system 300 or any operation therein may be carried out in any desired environment.

The provider profile is a data structure comprising, at the least, fields for provider name, provider contact information, description of needs served, specific needs types served (from a pulldown), etc. In exemplary embodiments, the organization of the data structure might be defined by industry-accepted parameters in order to heighten the probability of a successful match between provider and member. Strictly as an example it might include data fields as defined by one or more industry representatives. Shown in FIG. 3 is an operation to collect statistical information for an acquired candidate provider profile 302. In this operation, a provider candidate (i.e. a provider that has not yet been authorized for entry, see operation 314) becomes the subject of retrieval of general statistical information such as, into what category or provider type does the provider fit (and such provider type is captured into the provider profile), how does the candidate provider rank across all same-type providers in the nation, or how does it rank across all same-type providers covering the same geographic area, etc. In this manner a particular provider candidate may be pre-screened before being added to any list or database of providers. In some cases, the candidate provider might be a for-profit entity, or a member of a professional organization or association, or a not-for-profit organization, or even a social networking entity. Strictly as an example, a generic listing of possible entities is presented herein in Table 1. As shown the entities listed are organized into three columns corresponding to provider types for each of three exemplary life cycle phases being the accumulate phase, the conserve phase, and the resolve phase. These column headings are strictly exemplary and relatively more or less granular lists are possible and conceived.

TABLE 1

| Provider Type: | Provider Type: | Provider Type: |
|---|---|---|
| Accumulate Phase | Conserve Phase | Resolve Phase |
| Career Management Alliance | Investment Adviser | Assisted Living Federation of |
| | Association | America |
| National Association of | Trusted ID | American Association of |
| Professional Organizers | | Service Coordinators |
| Financial Planning | Medic Alert | National Association of |
| Association | | Professional Geriatric Care |
| | | Managers |
| American Association of | Martindale.com | National Hospice and Palliative |
| Family and Consumer | | Care Organization |
| Services | | |
| American Bankers | Caring Bridge | International Cemetery, |
| Association | | Cremation and Funeral |
| | | Association |
| Realogy | National Family Caregivers | Final Exit Network |
| | Association | |
| Consumer Federation of | American Society on Aging | Legacy.com |
| America | | |
| National Association of | American Animal Hospital | |
| Professional Insurance | Association | |
| Agents | | |
| American Institute of | National Genealogical Society | |
| Certified Public Accountants | | |
| National Association of | Society for Human Resource | |
| Insurance and Financial | Management | |
| Advisors | | |
| | American Association for | |
| | Marriage & Family Therapy | |
| | National Association of Estate | |
| | Planners and Councils | |
| | National Academy of Elder | |
| | Law Attorneys | |

The Table 1 lists but a few of the possible entries. In fact, some embodiments collect tens of thousands of candidate providers for processing under the system for collecting provider input to create provider member profiles 300.

Continuing, in operation 304, the candidate provider is checked against statistical data acquired from provider data within the system 100. Examples of such statistical inquiry and measurements include, how many of such providers of the same provider type are already in the system 100, or how many of such providers serving the same geographic area are already in the system 100, etc.

The abovementioned operation 304 may include a filtering operation such that providers are flagged or ranked so that members can easily discover any irregularities or deviance from the provider's usual, customary and/or required adherence to industry standards and codes of ethical behavior. The number of providers listed in any particular practice area may be limited or pre-qualified using geographic or other variables.

Of course automatically-generated provider profiles, even with statistical information populated within the profile, generally do not fairly represent the entire profile of the provider, so the system 300 defines an operation for obtaining second-level information for being received into said profiles 306. Those skilled in the art will readily recognize that there exist many techniques for obtaining second-level information including direct inquiry to a human operator via a screen device such as a pull-down. Regardless of the technique used to obtain information from this second-level inquiry, the specific information gathered is extensible. In other words, as time progresses and business conditions or demographics change, the form of the inquiry for this second-level information may be extended. For example, at one point in time, the second-level inquiry might ask for an “800 number”, but later in time might be broadened to inquire for a “toll free number”, and at a still later point in time, might ask for a “Skype number”. Of course the foregoing is merely an example of extensibility, and the emphasis of this paragraph is to call out the extensibility of the profiles and match objects used in the system 100.

In some cases during operations 304 and/or 306 it may become apparent that some providers may provide multiple types of services (e.g. may provide financial planning as well as being licensed or certified to handle the purchase or sale of securities, sell life insurance, etc.) and may choose to list in multiple industries. In such a case, the provider may be guided through multiple passes of the steps of system 300.

Now, with a generally well-populated provider profile, the system 300 can rank the candidate provider with the profiles of other providers. So the system 300 defines an operation for ranking a provider profile relative to the profiles of other pre-existing provider profiles 308. Assuming the ranking is above some threshold value and the profile is rejected in decision 310, the profile is then prepared for presenting a match object to the user for review and authorization 314. It should be noted that all operations shown in the system 300 need not be executed strictly in the order shown, and moreover the operations for obtaining second-level information for being received into said profiles 306 and the operation for presenting a ranked match object to the user for review and authorization 314 might be performed by different individuals considering one or more variables or even considering no variables at all (e.g. an unranked list of all providers).

Now, once a provider has been vetted at least to the extent that the provider's profile can be added to the data store of the system 100, the profile may be further processed so as to facilitate operations relating to the provider.

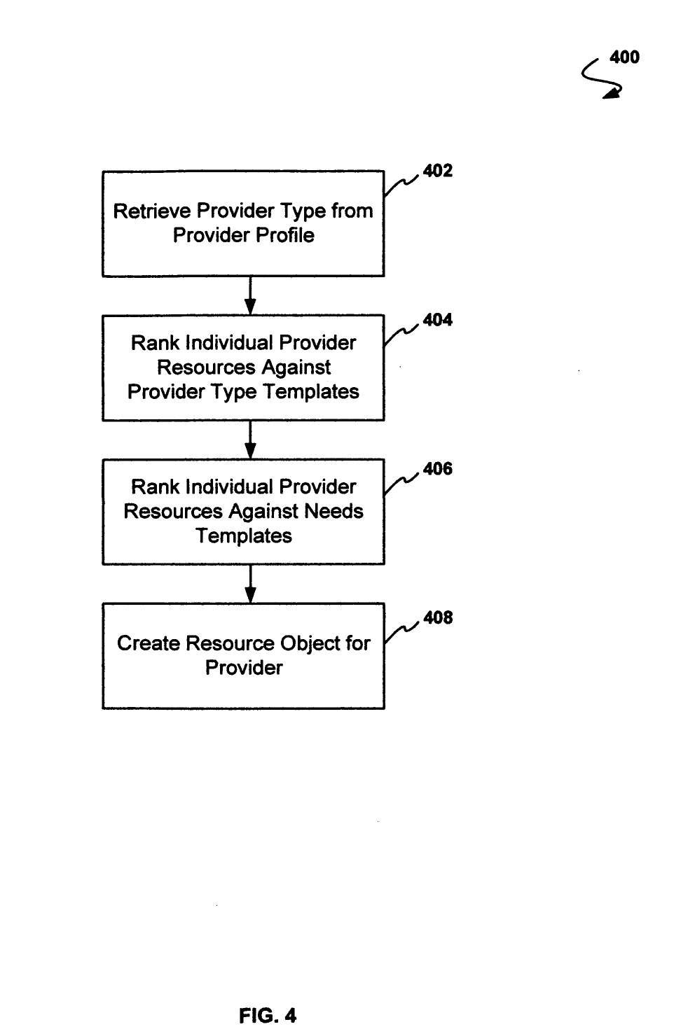

FIG. 4 shows a system for creating a match object from a provider profile 400, in accordance with another embodiment. As an option, the present system 400 may be implemented in the context of the architecture and functionality of FIG. 1 through FIG. 3. Of course, however, the system 400 or any operation therein may be carried out in any desired environment.

As shown the provider type is established from the provider profile in operation 402.

With the provider type known it is possible to ratify the provider type (see operation 404) and the needs template type. That is, it is possible to rank the provider resources in comparison to a list of needs templates to identify the most appropriate templates (see operation 406). As shown in Table 2, there is a many-to-many relationship between a provider type and a needs template type. For example, the Financial Planning Association (FPA) may be classified as having provider type P1, and capable of serving the needs of needs type “Financial Literacy”. And the FPA may also be classified as being capable to serve the needs for needs type “Financial Planning”. Thus the information in the profile for FPA may be evaluated in relationship to the profiles for all other providers serving the same needs types. It should be recognized the value of this operation; namely while some service provider, say the Omaha Association of Financial Planners, may rank low when scored in relationship to other providers on the point of needs type “Financial Planning”, it still may be a good match for a member who seeks to satisfy Financial Planning needs from a provider located in Omaha. In fact there are many cases where providers belong to their State or Regional Associations but not their National Association.

TABLE 2

| | | | Needs |
|---|---|---|---|
| | | Provider | Template |
| Needs Type | Provider Name | Type | Type |
| Financial Literacy | Financial Planning | P1 | T1 |
| | Association | | |
| Financial Planning | Financial Planning | P1 | T2 |
| | Association | | |
| Financial Planning | National Association | P2 | T2 |
| | of Insurance and | | |
| | Financial Advisors | | |
| Medical | Medic Alert | P3 | T3 |
| Emergency Support | | | |
| Career Counseling | Career Management | P4 | T4 |
| | Alliance | | |
| Financial Literacy | Omaha Association of | P1 | T1 |
| | Individual Investors | | |
| Financial Planning | Omaha Association of | P1 | T2 |
| | Individual Investors | | |

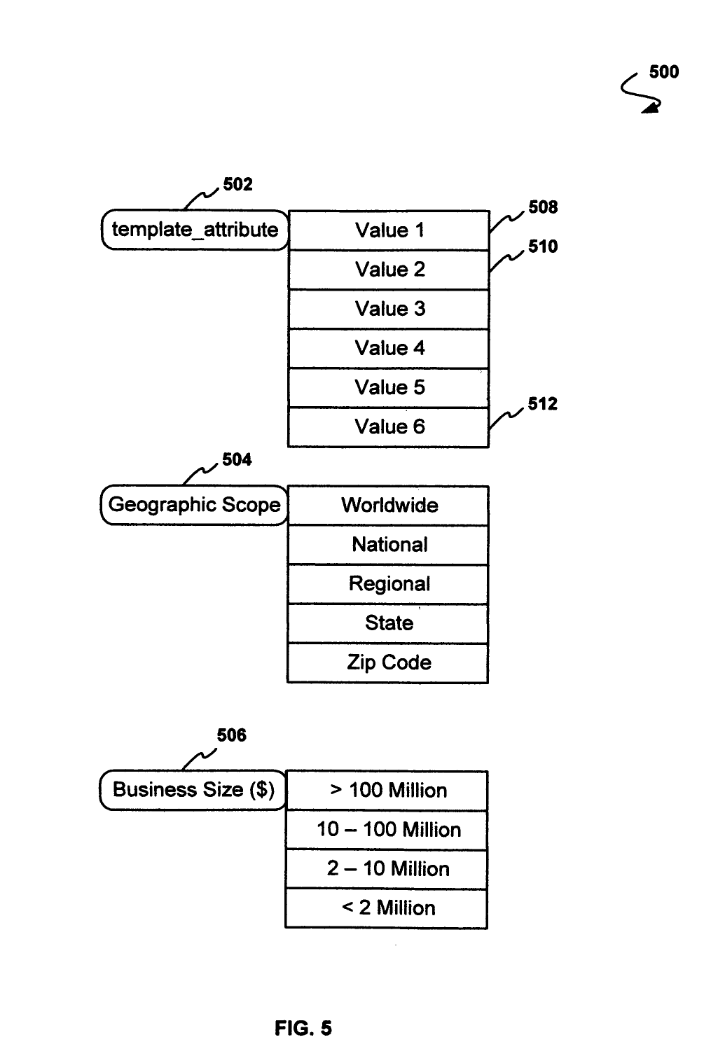

Of course, once one or more needs template types have been identified, the fields in the template may be populated. The needs template types described herein provide a technique for assigning unambiguous, objective, discrete values to various characteristics. As shown in FIG. 5, the screen devices 500 present characteristics, and possible discrete values, in accordance with another embodiment. As an option, the present system 50Q may be implemented in the context of the architecture and functionality of FIG. 1 through FIG. 4. Of course, however, the system 500 or any operation therein may be carried out in any desired environment.

Strictly as an example, the aforementioned discrete values might be presented as a screen device with one or more pull-downs for (for example) geographic scope (504) for which only discrete values are presented. Even in cases of a range, discrete values may still be used, for example an inquiry into business size 506 might provide a set of one or more ranges. More generally an arbitrary template attribute can be presented as a screen device (502) with a corresponding set of discrete values (508, 510, 512).

As will be appreciated by those skilled in the art, now, with discrete values assigned to various characteristics related to the needs type of the provider as captured in the needs type, operation 406 may proceed for ranking individual provider resources against needs templates. Moreover, once the resources available have been characterized with the aforementioned discrete values, a match object for the provider can be created (operation 408).

Although the disclosure has thus far introduced the concept of a needs type, the use model has focused on the uses of needs type as applied to a provider profile. Of course, the function of system 100 to match members to providers may be facilitated by techniques to extract, infer, or respond to the self-diagnoses of the needs of the member.

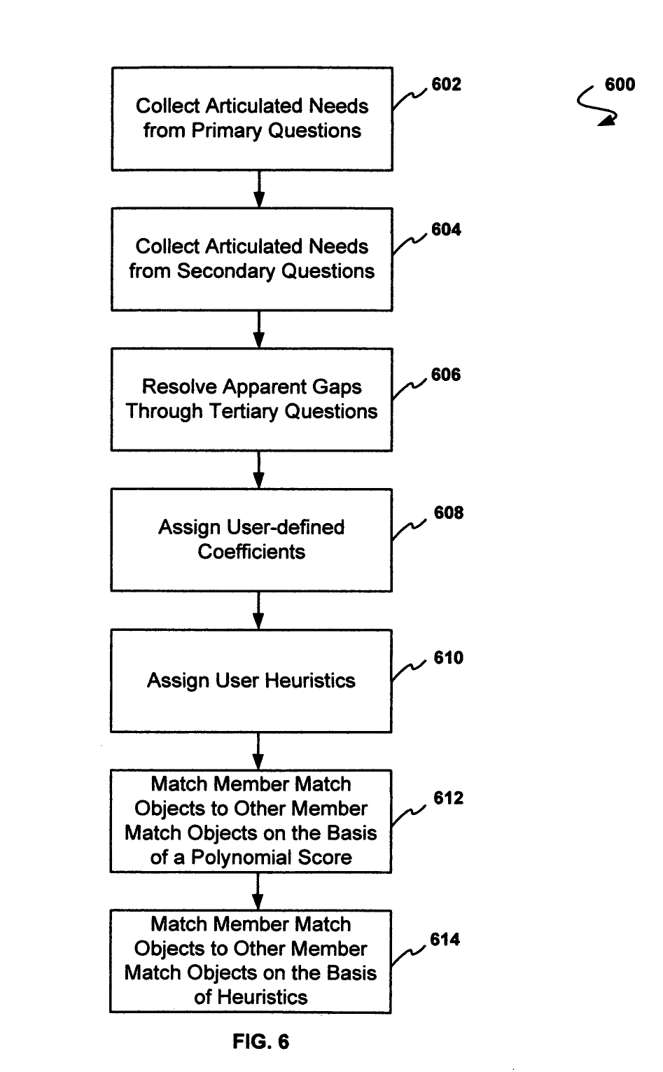

FIG. 6 shows a system for creating matches on the basis of needs 600, in accordance with one embodiment. As an option, the present system 600 may be implemented in the context of the architecture and functionality of FIG. 1 through FIG. 5. Of course, however, the system 600 or any operation therein may be carried out in any desired environment.

As shown the system 600 begins by assessing needs that have been articulated since they result from the member completing their Life Path Profile Organizer. However these needs could be identified at any point in time via a direct question and answer session with a member administered by a process or may be administered “live” by telephone or chat or email, or some other interactive exchange. The session could be facilitated by automation and screen devices described in FIGS. 2B through 2E, or the session may be facilitated by any other means of communication, including a telephone or personal interview. As observed, even a well considered set of primary and secondary questions may not be effective to resolve to the member's true and full needs. In some embodiments, the answers to the primary and secondary questions are analyzed to identify gaps in the answer set, and propose tertiary questions to resolve apparent gaps 606. For example, if a respondent answers through primary and secondary questioning that he/she has no appreciable assets yet again through primary and secondary questioning indicates that he/she desires two million dollars of life insurance, a possible tertiary question might be, “please confirm the number of dependents”, or even simply, “Why?”. Thus the operation 606 aids in resolving gaps through tertiary questions.

As mentioned previously it should be recognized that the data in any member profile may be sensitive data. As such, any profile may (strictly as an option) be associated with an access key (e.g. a password, an encryption key, etc). With the articulated needs from operations 602 and 604 and the implied or resolved needs of operation 606, the system 600 may then create multi-axis match objects.

Continuing with the discussion of the system 600, the operation 612 is for matching a member match object to other member match objects on the basis of a polynomial score. As earlier indicated, closeness of a match with regard to a particular axis may be a simple matter of arithmetic, or it may be more subjective, or a match on a particular variable may be made on the basis of a non-linear function. In general the formula for scoring X vs Y using a multi-axis polynomial is:

Vscore_{XY}=U1F1(x1,y1)+U2F2(x2,y2)+ . . . UnFn(xn,yn)
Where: U₁-Uₙ are user-defined coefficients that weight the importance of a match on a particular axis, and F₁-Fₙ are comparison functions for comparing two values within the same axis, and x1 . . . xn and y1 . . . yn are axis values of the corresponding vectors X and Y.

Of course a scoring technique using user-defined coefficients (see operation 608) is only one way to identify one match as being relatively better than another match. And in some situations, in fact, it might be more accurate to match on the basis of heuristics or rules (see operation 610). For example, and by comparison instead of increasing a particular user coefficient to make it relatively more important than some other coefficient it may be more effective to select/reject on the basis of set operations or other rules. For example, a match heuristic might be defined to codify the expression, “Give me only financial planners who are certified by the United States Financial Planning Certification Board and are located in Philadelphia, Pa.”. Thus the system 600 might provide an operation for matching a member match object to other member match objects on the basis of a heuristic match (operation 614).

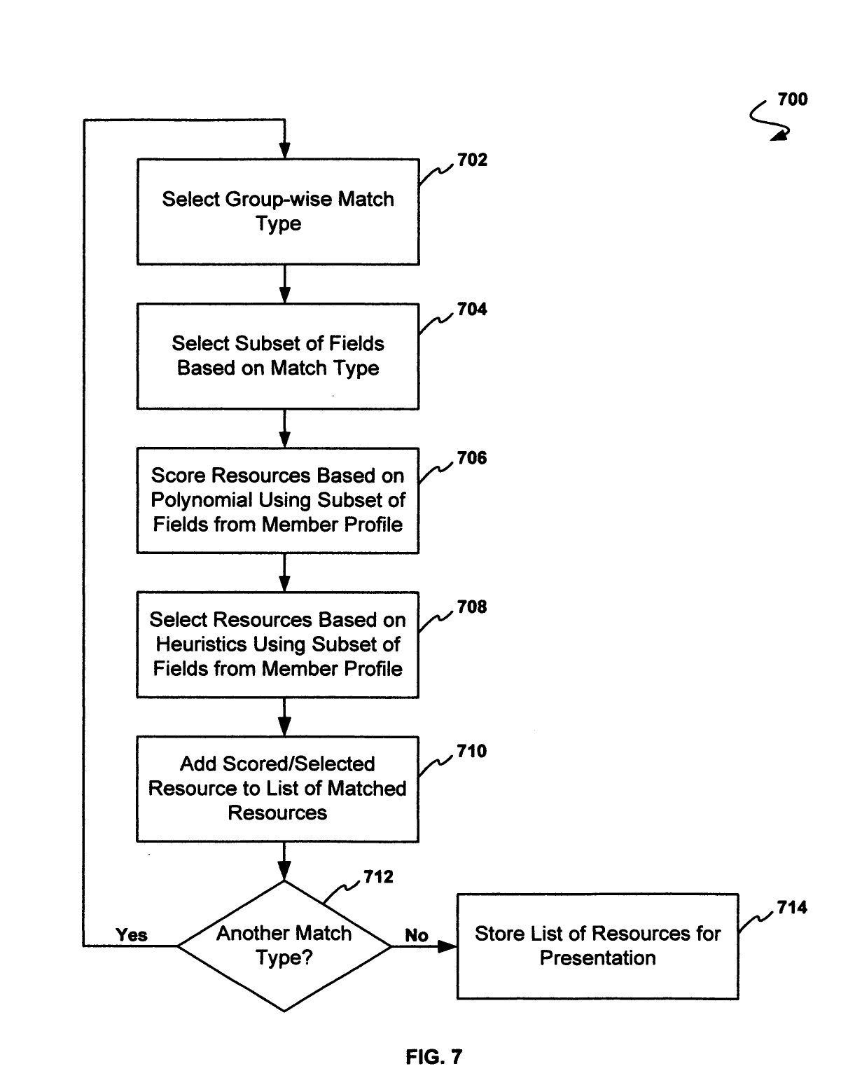

FIG. 7 shows a system for creating a list of resources based on a plurality of match types 700, in accordance with one embodiment. As an option, the present system 700 may be implemented in the context of the architecture and functionality of FIG. 1 through FIG. 6. Of course, however, the system 700 or any operation therein may be carried out in any desired environment.

The ability to perform matches involving multiple axes have thus been described, and the concept of match types may now be attended to. It is sufficient to simply mention that the number of axes or variables involved in a match (whether by scoring or by heuristics) may be unwieldy. Some means to abstract a group of related variables needs to be defined, and once defined, the match functions carried out on the group of variables can be abstracted to the match type. By way of a previously introduced example, if a member notes that a particular provider has earned various certifications (usually represented by an acronym such as CFP for a financial planner), he/she may, by using one or more GUI devices (e.g. a mouse click), access a link to that acronym definition to determine credentialing protocols and details of the certification, or certification body, or certification level, etc. That provider's membership in their state, regional or national industry specific association can also be easily noted and a link established to determine a particular provider's standing. Thus all variables in the match object for a particular provider can thus be abstracted into a match type. The foregoing is merely but an example and any number of groups of variables may be defined as a group-wise match type. As shown in FIG. 7, the system 700, given a set of group-wise match types, the system will iterate over the set and, based on a specific group-wise match type value (operation 702), will score (operation 706) and/or apply heuristics (operation 708) to a subset of fields using solely a subset of fields based on the specific match type, where the selected variables are associated with the selected match type (operation 704). The aforementioned association can be defined by the existence of a statically defined table, or a table or mapping may be created on the basis of any extensible functions, or any other known mapping technique. Strictly as an option the selection of a subset of fields based on the specific match type may include an anonymous mode for a provider, or for a member, or both, whereby the selected field containing personally identifiable information are either not selected, or (optionally) are selected but are presented in a manner that does not divulge personally identifiable information. Once the iteration is complete (see decision 712), the scored or selected-in list (see operation 710) of providers may be stored for presentation (see operation 714). In this manner a member's network of providers may be stored and presented.

In some embodiments the creation of a member-configured subordinate profile (as detailed above) or the use of an anonymous subordinate profile allows the member to opt-in to one or more programs for presenting their dataset to marketers and other members. The member may be provided with one or more GUI devices (e.g. a mouse click) to reveal a single or multiple identifying field to “opt-in”. In still other embodiments, the member may be offered the chance to earn remuneration by identifying themselves to, and/or purchasing goods or services offered by, providers and/or advertisers.

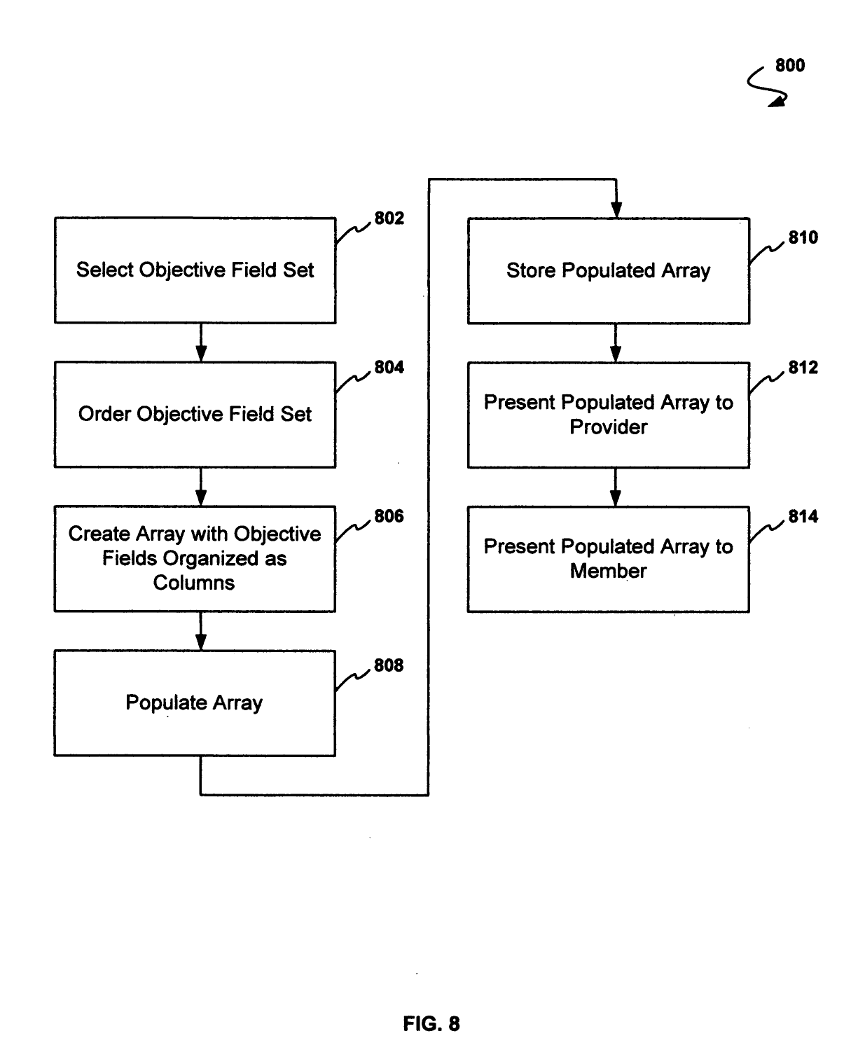

FIG. 8 shows a system for populating an array for presentation 800, in accordance with one embodiment. As an option, the present system 800 may be implemented in the context of the architecture and functionality of FIG. 1 through FIG. 7. Of course, however, the system 800 or any operation therein may be carried out in any desired environment.

Inasmuch as providers tend to use targeted marketing techniques in order to identify qualified leads, and inasmuch as the system 100 is operable as a repository for potentially qualified leads, it is axiomatic to provide the facility to select and present members to providers or advertisers. It is well known in the arts that targeted marketing becomes more effective the more narrowly the target can be defined (assuming the data exists to discern such a narrow target). Accordingly, objective field sets that are potentially interesting or valuable to providers or advertisers are selected (see operation 802) and prioritized. With the set of objectives both known and ordered, an array may be populated from the member data.

For example, a provider may query, “Give me all members (opt-in or anonymous) residing in the state of Utah who earn over $25,000 per year and whose dataset defines a need for, or who have expressed a need for, health insurance. In such a case, the select objective field set could contain (a) state of residence, (b) needs include “Health insurance”, and (c) yearly income greater than $25,000. The order of the objective field set would be (d) phone number, and (e) email alias. Those skilled in the art will readily recognize that a modern query language may be operable for selecting objective field sets, and can express a query retrieval set (operations 802 and 804) and, can also express the form of the report to be generated from the retrieval set (operations 806 and 808). The results of the aforementioned query may be stored and/or ratified/confirmed by presenting an array of match field sets to a user for user selection (operation 812).

In another embodiment, members may wish to identify other members in order to find other people “just like them” using the techniques of system 800. In such an embodiment, the array created and stored in operations 808 and 810 respectively may be presented to a member (operation 814).

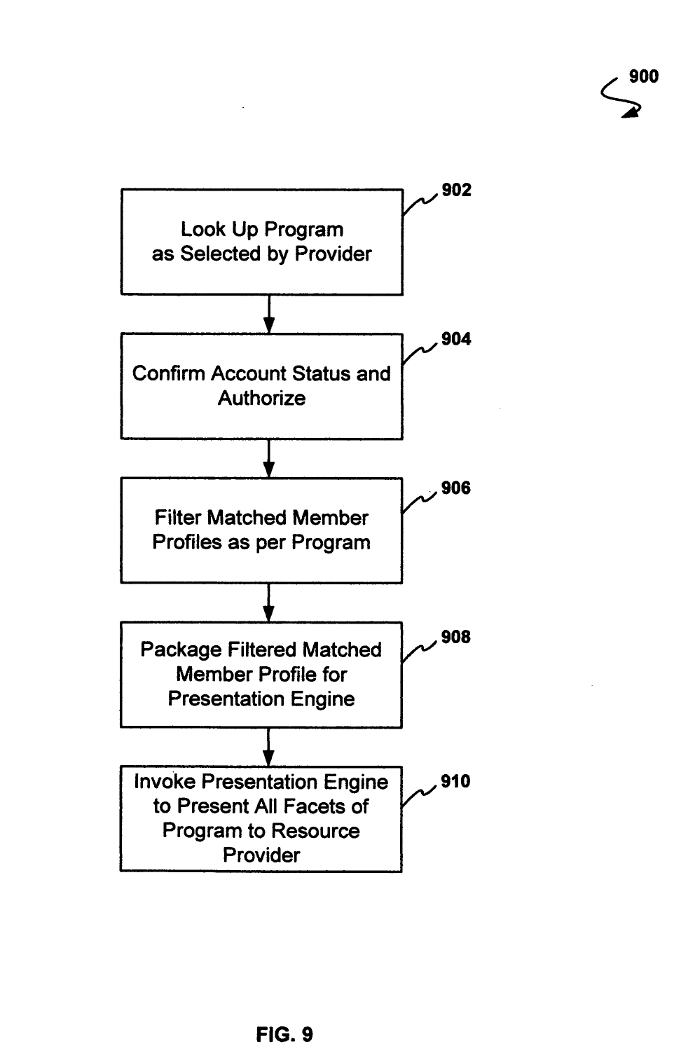

FIG. 9 shows a system for preparing a package for a presentation engine 900, in accordance with one embodiment. As an option, the present system 900 may be implemented in the context of the architecture and functionality of FIG. 1 through FIG. 8. Of course, however, the system 900 or any operation therein may be carried out in any desired environment.

In preferred embodiments, the system for preparing a package for a presentation engine 900 may look up the profile of the requesting provider and confirm that the provider has an election, and (optional) payment, and other account status needed for authorization and access to the marketing/mining program requested (operations 902, 904). Once the provider-requested program has been authorized, the specific database of matches is filtered (906) and packaged (908) for a presentation engine. This package is then used in the operation for invoking a presentation engine (910) to present program facets to a resource provider.

In some embodiments of a presentation engine, one or more of the aforementioned screen devices may be used. Of course any known methods for presenting information to a user via a computer display may be used.

In some cases, the presentation may include multiple screens that can be navigated in similar fashion to navigation through Internet html pages, and may include hints and tips, help-text, pop-ups, and any other known devices for navigation and for easing the absorption of complex data. Strictly as an option such presentation and navigation aids may include access to acronym definitions and underlying credentialing requirements, and optionally an acronym dictionary.

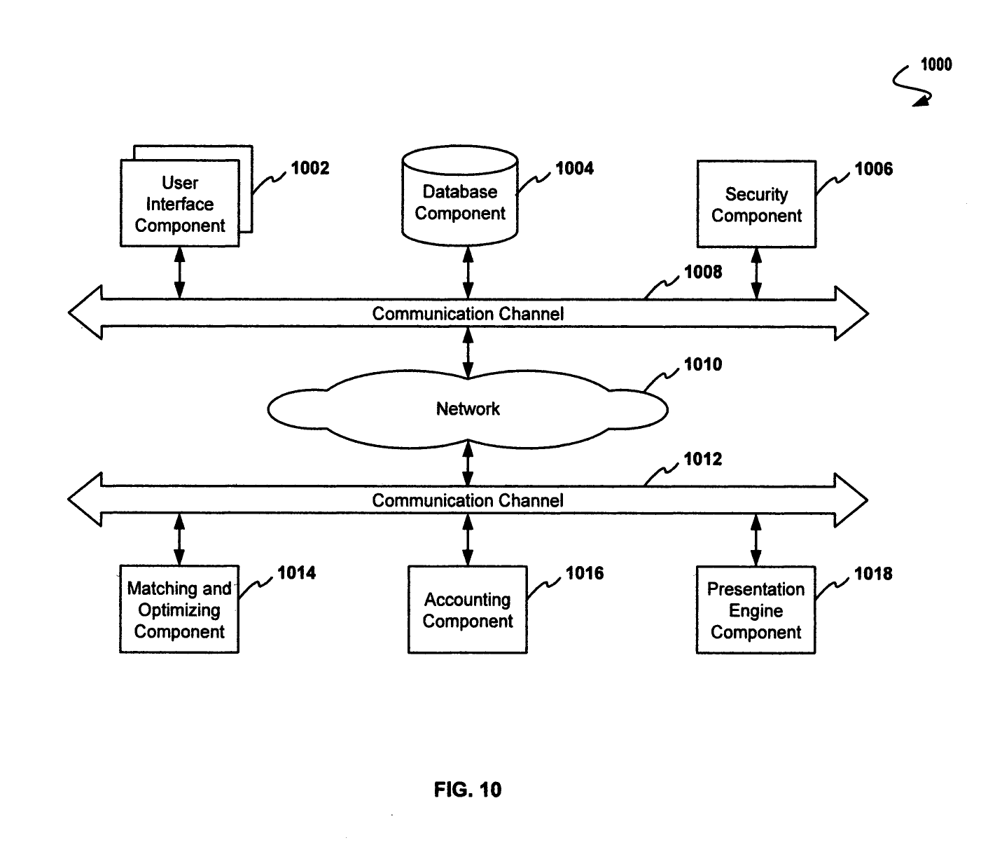

FIG. 10 depicts a possible mapping of a system for practicing the method for universal life path decision support 100. As shown, a user interface component 1002, a database component 1004, and a security component 1006 are all in communication, one with another via a first communication channel 1008. Similarly, the matching and optimizing component 1014, accounting component 1016, and presentation engine component 1018 are in communication via a second communication channel 1012, as shown. In some embodiments, there may be optionally a network cloud 1010 for communication between the first communication channel 1008 and the second communication channel 1012. Also, in some embodiments, the first communication channel 1008 may be the same, or otherwise indistinguishable, from the second communication channel 1012. Within the flexibility of such possible mappings, one skilled in the art can readily see that the user interface component 1002 might be adapted to be operable on a laptop computer in communication with, for example, the transaction approval component, with such communication taking place over the network. In exemplary embodiments, there may be more than one instance of a user interface component 1002, and in some embodiments, one instance of a user interface component 1002 may share some or no similarities to a second or nth user interface component 1002.

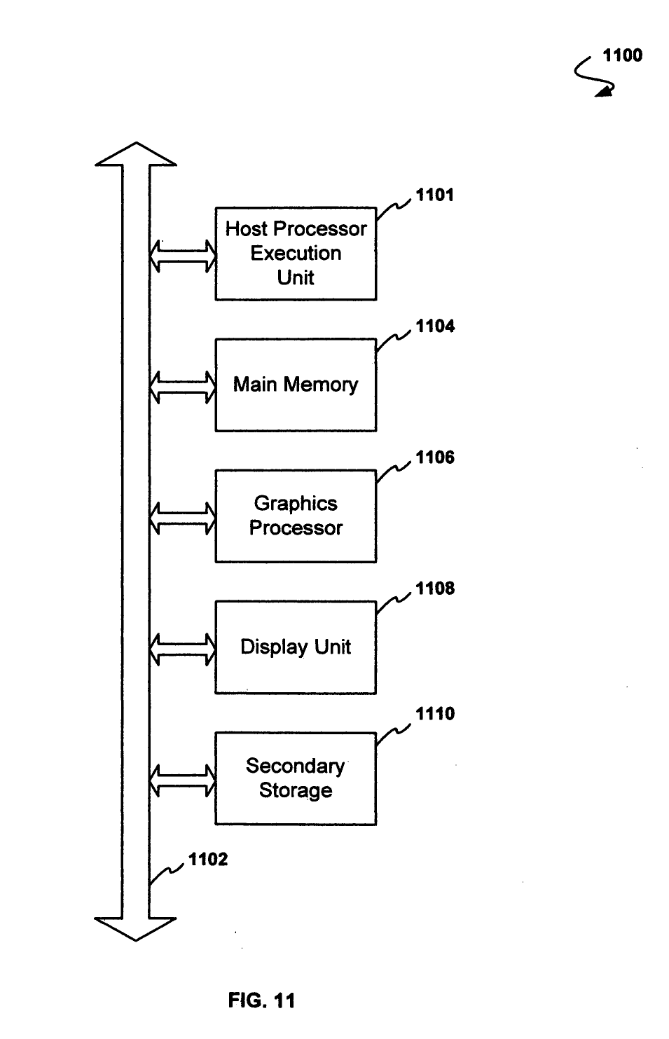

FIG. 11 illustrates an exemplary system 1100 in which the architecture and/or functionality of the various previous embodiments may be implemented. As shown, a system 1100 is provided including at least one host processor 1101, which is connected to a communication bus 1102. The system 1100 also includes a main memory 1104; Control logic (software) and data are stored in the main memory 1104 which may take the form of random access memory (RAM).

The system 1100 also includes a graphics processor 1106 and a display 1108, i.e. a computer monitor.

In the present description, a single semiconductor platform may refer to a sole unitary semiconductor-based integrated circuit or chip. It should be noted that the term single semiconductor platform may also refer to multi-chip modules with increased connectivity and which simulate on-chip operation, and make substantial improvements over use of a conventional central processing unit (CPU) and bus implementation. Of course, the various modules may also be situated separately or in various combinations of semiconductor platforms.

The system 1100 may also include a secondary storage 1110. The secondary storage 1110 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1104 and/or the secondary storage 1110. Such computer programs, when executed, enable the system 1100 to perform various functions. Memory 1104, storage 1110, and/or any other storage are possible examples of computer-readable media.

In one embodiment, the architecture and/or functionality of the various previous figures may be implemented in the context of the host processor 1101, graphics processor 1106, an integrated circuit (not shown) that is capable of at least a portion of the capabilities of both the host processor 1101, and the graphics processor 1106.

Still yet, the architecture and/or functionality of the various previous figures may be implemented in the context of a general computer system, a circuit board system, a PDA, a game console system dedicated for entertainment purposes, an application-specific system, and/or any other desired system. For example, the system 1100 may take the form of a desktop computer, laptop computer, and/or any other type of logic. Still yet, the system 1100 may take the form of various other devices including, but not limited to, a personal digital assistant device, a mobile phone device, a television, etc.

Further, while not shown, the system 1100 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

We claim:

1. A method for universal life path decision support comprising:
collecting user input to create provider profiles and member profiles;
creating multi-axis match objects from the provider profiles and member profiles;
applying heuristics to create implied multi-axis match objects from the provider and member profiles;
filtering, scoring and selecting a selection set of matches from among a candidate set containing the multi-axis match objects and the implied multi-axis match objects; and
presenting said selection set of matches to a user.

2. The method of claim 1 wherein, collecting user input to create provider profiles and member profiles includes collecting biographical data.

3. The method of claim 1 wherein, collecting user input to create provider profiles and member profiles includes using a screen device having a plurality of sliders for representing characteristics on a scale.

4. The method of claim 1 wherein, collecting user input to create provider profiles and member profiles includes a screen device having at least one progress bar.

5. The method of claim 1 wherein, collecting user input to create provider profiles and member profiles includes collecting statistical information from a group of said provider profiles and member profiles.

6. The method of claim 1 wherein creating multi-axis match objects from provider profiles and member profiles includes obtaining second-level information for being received into said profiles.

7. The method of claim 1 wherein creating multi-axis match objects from provider profiles and member profiles includes ranking said profiles against other pre-existing profiles.

8. The method of claim 1 wherein creating multi-axis match objects from provider profiles and member profiles includes presenting a ranked match object to a user for review and authorization.

9. The method of claim 1 wherein creating multi-axis match objects from provider profiles and member profiles includes ranking individual provider resources against one or more needs templates.

10. The method of claim 1 wherein applying heuristics to create implied multi-axis match objects from provider and member profiles includes collecting articulated needs through primary and secondary questions.

11. The method of claim 1 wherein applying heuristics to create implied multi-axis match objects from provider and member profiles includes resolving gaps through tertiary questions.

12. The method of claim 1 wherein filtering, scoring and selecting a set of matches between the multi-axis match objects includes matching a member match object to other member match objects on the basis of a polynomial match.

13. The method of claim 1 wherein filtering, scoring and selecting a set of matches between the multi-axis match objects includes matching a member match object to other member match objects on the basis of a heuristic match.

14. The method of claim 1 wherein, filtering, scoring and selecting a set of matches between the multi-axis match objects includes; matching on the basis of one or more match types.

15. The method of claim 1 wherein, filtering, scoring and selecting a set of matches between the multi-axis match objects includes selecting a subset of fields drawn from one or more match types.

16. The method of claim 1 wherein, presenting said set of matches to a user includes selecting objective field sets.

17. The method of claim 1 wherein, presenting said set of matches to a user includes presenting an array of match field sets to a user.

18. The method of claim 1 wherein, presenting said set of matches to a user includes invoking a presentation engine to present program facets to a resource provider.

19. An apparatus for universal life path decision support comprising:
an execution unit for collecting user input to create provider profiles and member profiles;
an execution unit for creating multi-axis match objects from the provider profiles and member profiles;
an execution unit for applying heuristics to create implied multi-axis match objects from the provider and member profiles;
an execution unit for filtering, scoring and selecting a selection set of matches from among a candidate set containing the multi-axis match objects and the implied multi-axis match objects; and
an execution unit for presenting said selection set of matches to a user.

20. A computer program product embodied on a tangible computer readable medium for universal life path decision support comprising:
computer code for collecting user input to create provider profiles and member profiles;
computer code for creating multi-axis match objects from the provider profiles and member profiles;
computer code for applying heuristics to create implied multi-axis match objects from the provider and member profiles;
computer code for filtering, scoring and selecting a selection set of matches from among a candidate set containing the multi-axis match objects and the implied multi-axis match objects; and
computer code for presenting said selection set of matches to a user.
